(19) United States
(12) Patent Application Publication
(10) Pub. No.: US 2010/0107417 A1
(43) Pub. Date: May 6, 2010

(54) Eating utensil incorporating dental flosser

(76) Inventor: Jackson L. Crisp, Bakersfield, CA (US)

Correspondence Address: J.E. McTaggart;U.S. Patent Agent, 6650 Crescent Street, Suite 4, VENTURA, CA, 93003, US

(21) Appl. No.: 12/231,274

(22) Filed: Sep. 2, 2008

Related U.S. Application Data
(60) Provisional application No. 61/133,106, filed on Jun. 25, 2008.

(51) Int. Cl. A47J 43/28; A61C 15/00

(52) U.S. Cl. 30/122; 30/123; 30/322; 30/324; 132/321

(57) ABSTRACT

An eating utensil such as a disposable plastic fork, spoon or knife, or combination thereof, is combined with a dental cleaning device such as a toothpick and/or a dental flosser for personal use after eating in a location where dental hygiene items may not be otherwise available. In some embodiments the dental cleaning device may be permanently attached to the eating utensil, which can serve as a handle for using the dental cleaning device; in other embodiments the dental cleaning device may be removed in a snap-off manner for convenient deployment independent of the eating utensil, optionally configured with a thumb-finger tab.

### PRIORITY

Priority is claimed for provisional patent application 06/1,133,106 filed Jun. 25, 2008.

### FIELD OF THE INVENTION

The present invention is in the fields of eating utensils and dental cleaning devices, more particularly the invention relates to an eating utensil that incorporates a dental cleaning device.

### BACKGROUND OF THE INVENTION

Eating activity often involves the use of disposable eating utensils, such as plastic forks, spoons and/or knives, typically at away-from-home locations where devices for teeth cleaning after eating are unavailable. Such eating activity may include planned picnics, picnics-on-the-go, fast food, takeout, lunch boxes, bagged lunches at work, eating-on-the-go, delivered specialties, catered food engagements, entertainment events, birthdays, cocktail-parties, weddings and other parties.

### DISCUSSION OF KNOWN ART

U.S. design Pat. D254,239 to Julius for a COMBINED FORK AND SEPARATABLE TOOTHPICK shows the ornamental design for the subject matter.

U.S. design Pat. D463,221 to Sanders for EATING UTENSIL WITH TOOTHPICK INCORPORATED THEREIN shows a fork, spoon and knife each with a toothpick located on the front side near the handle end; presumably the toothpick is removably attached in each case.

U.S. Pat. No. 2,877,547 for COMBINATION TOOTHPICK AND STIRRING OR EATING IMPLEMENT to Feaster discloses wooden spoons, forks and stirring sticks configured with knockout-removable toothpicks.

U.S. Pat. No. 2,072,777 to Takahashi for CUTLERY shows a spoon and a fork each with a pair of toothpicks removably attached on the rear side.

U.S. Pat. No. 3,664,020 to Hammond et al for COMBINATION SPOON AND TOOTHPICK shows and discloses a toothpick and spoon combination including a handle portion with a separable toothpick member for use after eating. The combination utilizes support members from which the toothpick may be broken away.

### OBJECTS OF THE INVENTION

It is a primary object of the present invention to provide disposable plastic utensils incorporating a dental hygene device such as a toothpick and/or dental floss for maintaining good oral health at eating events where dental hygene devices may not be otherwise available

It is a further object to provide an embodiment including a toothpick configured with a hooked or otherwise offset point for reaching and cleaning regions of the teeth that are virtually inaccessible with a conventional straight toothpick.

### SUMMARY OF THE INVENTION

The foregoing objects have been met in the present invention wherein a plastic spoon, fork, knife of combination thereof is equipped with a removable dental cleaning device such as a toothpick and/or mounted dental floss for use after eating in a location where dental hygiene items may not be otherwise available.

### BRIEF DESCRIPTION OF THE DRAWINGS

The above and further objects, features and advantages of the present invention will be more fully understood from the following description taken with the accompanying drawings in which each drawing represents an embodiment of the present invention:

FIG. 1 shows a front view of a fork configured with an attached curved toothpick and an adjacent removable snap-off guard tab.

FIG. 2 depicts the fork of FIG. 1 showing a user's hands in process of removing the snap-off guard tab.

FIG. 3 depicts a fork with a snap-off curved toothpick that includes a thumb-finger grip.

FIG. 4 depicts a fork with a snap-off toothpick that includes an attached thumb-finger grip.

FIG. 5 depicts a fork with an attached toothpick protected by a snap-off guard portion.

FIG. 6 depicts a fork with a snap-off guarded curved toothpick that includes an attached thumb-finger grip.

FIG. 7 depicts a fork with a snap-off curved toothpick that includes a small attached thumb-finger grip.

FIG. 8 depicts a fork with a snap-off straight toothpick.

FIG. 9 depicts a fork with a snap-off guarded straight toothpick.

FIG. 10 depicts a fork with an unguarded attached ready-to-use curved toothpick oriented longitudinally.

FIG. 11 depicts a fork with an unguarded attached ready-to-use curved toothpick oriented laterally.

FIG. 12 depicts a fork configured with an attached ready-to-use flosser.

FIG. 13 depicts a fork configured with a snap-off combined flosser and toothpick.

FIG. 14 depicts a fork configured with a snap-off guarded toothpick combined with a flosser.

### DETAILED DESCRIPTION

FIG. 1 depicts a fork 10 configured with an attached curved toothpick 10A, protected on one side by an adjacent removable guard tab 10B that is made to snap off at score line 10C, where the plastic material is made thinner as required to enable the snap-off capability.

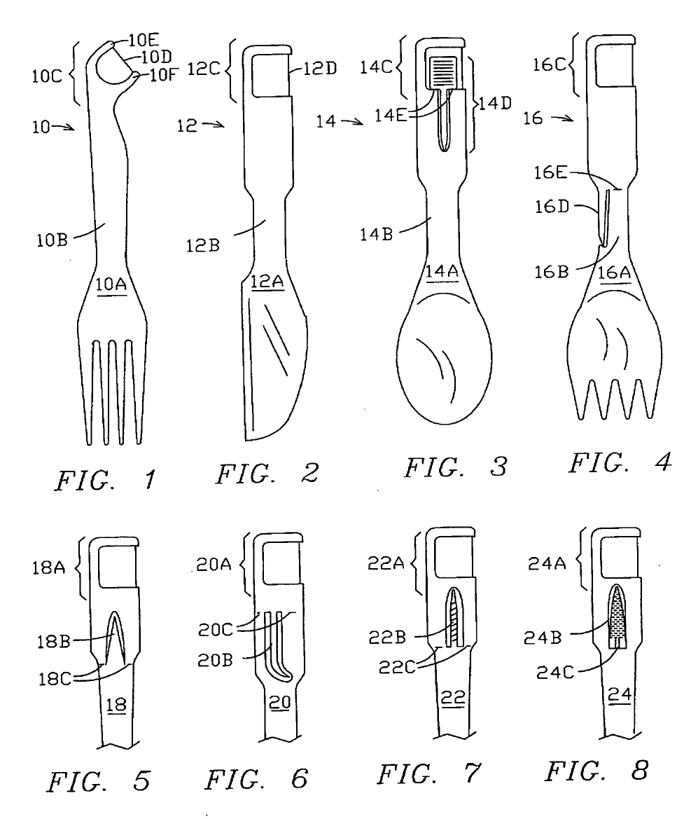

FIG. 2 shows a user's left hand 12A holding a fork 10 of FIG. 1 while the right hand 12B is shown in process of snapping off the guard tab 10B at score line 10C, to be removed and discarded, leaving the curved toothpick 10A ready to use, attached to fork 10 which serves as a handle.

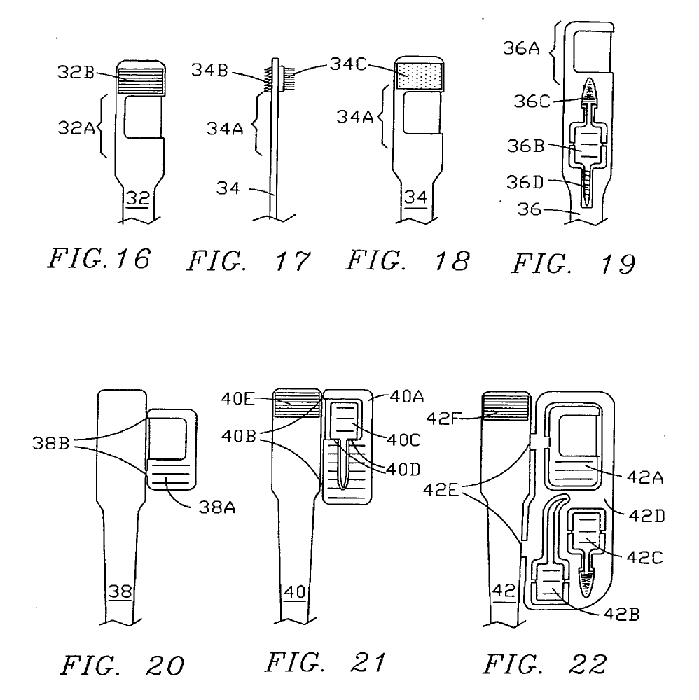

FIG. 3 depicts a fork 14 configured with a snap-off curved toothpick 14A, extending longitudinally from the handle. In a primary version, toothpick 14A is made readily removable by snapping off at score line 14B, providing the toothpick separately with a thumb-finger grip. In a secondary version, score line 14B is made relatively stiff so that toothpick 14A can be considered ready-to-use while remaining attached to fork 14 which serves as a handle. In still another version (FIG. 10), score line 14B is omitted.

FIG. 4 depicts a fork 16 configured with a snap-off portion that includes toothpick 16A attached to a grip tab 16C for gripping between thumb and finger to facilitate manipulating the toothpick 16A.

FIG. 5 depicts a fork 18 configured with an attached toothpick 18A that is fully protected by a snap-off guard portion 18B, which, when removed by snapping off at score lines 18C (and typically discarded), exposes the toothpick 18A ready to use, attached to the fork 18 which serves as a handle.

FIG. 6 depicts a fork 20 configured with a fully guarded snap-off curved toothpick 20A which, when snapped off at score lines 20B, includes a thumb-finger grip tab 20C.

FIG. 7 depicts a fork 22 configured with a partially-guarded snap-off curved toothpick 22A which, when snapped off at score line 22B, includes a triangular portion that can serve as a thumb-finger grip tab.

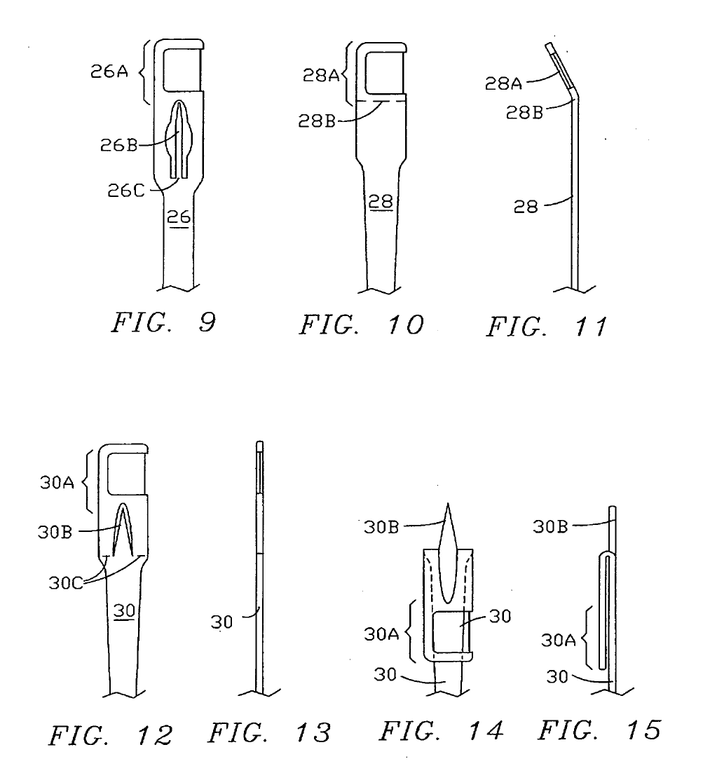

FIG. 8 depicts a fork 24 configured with a partially-guarded snap-off straight toothpick 24A that snaps off at score line 24B.

FIG. 9 depicts a fork 26 with a fully guarded straight toothpick 26A that snaps off at score line 26B, leaving the fork end 26C in place with its original outline shape intact.

FIG. 10 depicts a fork 28 with an unguarded attached curved toothpick 28A, oriented longitudinally, ready to use.

FIG. 11 depicts a fork 30 with an unguarded attached curved toothpick 30A, oriented laterally, ready to use.

FIG. 12 depicts a fork 32 in combination with an attached flosser 32A, ready to use. The floss in flosser 32A can be molded into the plastic at manufacture.

FIG. 13 depicts a fork 34 in combination with a flosser 34A, similar to flosser 32A in FIG. 12, combined with a partially guarded toothpick 34B. The combined flosser 32 and toothpick 34B can be snapped off from fork 34 at score line 34C with both dental cleaning devices, toothpick 34B and flosser 34A, then ready to use. If score line 34C is made relatively stiff, flosser 34A, while remaining attached to fork 34, could be regarded as ready to use with fork 34 serving as a handle.

FIG. 14 depicts a fork 36 in combination with a flosser 36A, similar to flosser 32A in FIG. 12 and flosser 34A in FIG. 13, combined with a fully guarded toothpick 36B. The combined flosser 36A and toothpick 36B can be snapped off from fork 36 at score lines 36C with both dental cleaning devices, toothpick 36B and flosser 36A, then ready to use separate from fork 36. If score lines 36C are made relatively stiff, flosser 36A, while remaining attached to fork 36, could be regarded as ready to use with fork 36 serving as a handle.

In an embodiment similar to that in FIG. 14, the cutout region flanking the fully guarded toothpick 36B could be inverted (i.e. rotated 180 degrees) to appear as in FIG. 5. Then the flosser 36A could be snapped off for use, exposing the toothpick (like 18A in FIG. 5) ready for use, still attached to the fork 35, which could serve as a handle for the toothpick.

While the invention has been shown practiced in the form of a fork as the eating utensil for illustrative purposes, it is to be understood that the invention can be practiced in conjunction with other eating utensils including but not limited to spoons, knives, chopsticks, tongs, and combinations thereof such as a spork combining a spoon and a fork.

While the invention is directed primarily to an unfulfilled need and expected demand in conjunction with disposable plastic eating utensils which are likely to be popular at picnics and other social or public eating events where regular dental cleaning facilities are unavailable, the invention could be practiced in conjunction with more permanent type eating utensils intended for more general use. The material in the eating utensil can be metal or any material that can provide the break-away feature. As an alternative to the generally one-piece construction shown for the eating utensil, it could be made from a plurality of parts joined by fastenings such as welding or adhesives.

Standard fork or spoon designs could include, but are not limited to, such features as ribbed-supports and similar structural/cosmetic elements.

The score lines can vary in configuration, type, shape and depth, i.e. thickness at the thinnest point. As an alternative to making the score lines to break-away, some items could be made to bend-away for use without actually detaching, or to remain sufficiently stiff to utilize the dental cleaning device while still attached to the eating utensil.

As alternatives to the dental cleaning device being attached to the eating utensil in a permanent or break-away manner with score lines as shown, the invention could be practiced with such attachment made by other fasteners such as temporary glue, magnets, snap-fits, Velcro or the like. It could be arranged for break-away parts to be re-attached.

In embodiments where the dental cleaning device is a toothpick, extreme sharpness at the working end of the toothpick should be avoided as hazardous; instead the point should be made slightly rounded, sufficient to avoid injury, while still shaped optimally to provide effective cleaning capability.

The dental cleaning device, shown as a toothpick or flosser, could also include items such as a tooth brush, finger-brush or tongue cleaner integrated into the eating utensil by attachment means such as mold-integration, adhesive or welding, or alternatively bundled in an eating-kit package including one or more eating utensils and/or related items such as a napkin.

As an alternative to floss where a flosser is shown, a rigid, semi-rigid or flexible thin fin or blade could be provided to clean between and around the teeth.

As an alternative to the flosser with a piece of floss suspended between two prongs as shown, the floss could be provided stored in the eating utensil body, attached loose thereto or bundle-wrapped.

For embodiments such as those shown in FIGS. 3, 10 and 11 where toothpick extends unguarded, a lid or cap of some kind could be included for use as a cover or sheath.

The dental cleaning device could further provide an appropriately designed rough or raised surface, located on its surface or on that of the eating utensil, that could aid in the removal of debris located on the inner walls of the teeth. The debris removal would occur on the insertion and removal of the dental cleaning device.

As an alternative to incorporating the dental cleaning device within or directly attached to the eating utensil, one or more cleaning device and one or more eating utensil could be included separately side-by-side in sheet of plastic made and arranged to enable break-away removal for use.

Supplemental items such as dental floss, tissue paper or mouth wash could be provided either separately, stored within or attached to the eating utensil body in some manner, optionally bundle-wrapped.

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

1. A combination eating utensil and oral hygienic facilities comprising:
an eating utensil portion of a type selected from a group consisting of forks, spoons, knives and combinations thereof;
a handle portion extending from said eating utensil portion to an end region;
a dental flosser formed in conjunction with said handle portion and configured with a flosser opening having two ends.
a length of dental floss extending between the two ends of the flosser opening; and
a toothpick formed in conjunction with said handle portion.

2. The combination eating utensil and oral hygienic facilities as defined in claim 1 wherein said dental flosser is located in the end region and said length of dental floss is fastened in place permanently at each of the two ends of the flosser opening.

3. The combination eating utensil and oral hygienic facilities as defined in claim 1 wherein:
said toothpick is an oral hygienic device of a type selected from a group including a straight toothpick, a tapered toothpick, a curved toothpick, an interdental pick, and an interdental brush; and
said toothpick is attached to the handle portion of said eating utensil in a manner to be initially guarded by adjacent handle material, and upon displacement manipulation by a user to become exposed ready for use.

4. The combination eating utensil and oral hygienic facilities as defined in claim 3 further comprising:
said toothpick being configured in said handle portion having a first side edge initially forming part of a first side edge of the handle portion; said toothpick being permanently attached to the end region of said handle portion at a baseline of said toothpick; and
a displacement-enabling score line, configured laterally on said handle portion collinear with the baseline of said toothpick, extending from a second and opposite side edge of said toothpick to a second and opposite side edge of the handle portion such that upon user-displacement of said toothpick as enabled by said score line said toothpick becomes exposed ready for use as an oral hygienic device attached to the end region which is available to serve as a thumb-finger grip.

5. The combination eating utensil and oral hygienic facilities as defined in claim 3 wherein:
said toothpick has a base end permanently attached to said handle portion initially located within a guard arch of handle material that extends to said flosser in the end region, for protection around the toothpick for normal usage of said eating utensil; and
a pair of score lines extending from said toothpick, at the base end thereof, to respective side edges of said handle portion, made and arranged to enable user-displacement of the end region as a unit including the guard arch and said flosser, at said score lines, such that upon user-displacement, said toothpick becomes exposed ready for use still permanently attached centrally onto the eating utensil handle portion as part thereof.

6. The combination eating utensil and device oral hygienic facilities as defined in claim 3 wherein said toothpick is formed in said handle portion, permanently base-attached to the end region, and outlined by a void region extending away from the end region into said handle portion thus forming a U-shaped guard arch of handle material for protection around the toothpick for normal usage of the eating utensil, said toothpick being thusly attached along with said dental flosser, forming an end region unit that is attached to said handle portion by a flanking pair of score lines such that upon displacement by a user, said toothpick becomes exposed ready for use.

7. The combination eating utensil and oral hygienic facilities as defined in claim 1 wherein said:
toothpick has a base end initially attached to said handle portion with a score line extending across the base en& made and arranged to enable snap-off removal of said toothpick at the score line, ready for use as a separate oral hygienic device.

8. The combination eating utensil and oral hygienic facilities as defined in claim 7 wherein the base end of said toothpick is initially located in the end region of said handle portion, with said toothpick oriented to extend in a direction toward said eating utensil portion.

9. The combination eating utensil and oral hygienic facilities as defined in claim 8 wherein said is initially disposed centrally in said handle portion, protected by surrounding material of said handle portion.

10. The combination eating utensil and oral hygienic facilities as defined in claim 3 wherein said dental flosser is located in the end region of said handle portion, the end region being demarked by a bend line, configured laterally across said handle portion made and arranged to allow flexible bending at the bend line, thus enabling a user to deploy said dental flosser at a desired angle relative to said handle portion.

11. The combination eating utensil and oral hygienic facilities as defined in claim 3 wherein said dental flosser is located in the end region of said handle portion, the end region is permanently bent back at a predetermined desired angle relative to said handle portion.

12. The combination eating utensil and oral hygienic facilities as defined in claim 3 further comprising:
said dental flosser being formed from the end region of said handle portion, the two ends of the flosser opening and the length of floss being located offset from a center line between two side edges of said handle portion toward a first side edge thereof ready for use.

13. The combination eating utensil and oral hygienic facilities as defined in claim 12 further comprising:
said toothpick being formed from and permanently attached to the end region along with said flosser; forming an oral hygiene unit; and
said handle portion being configured with at least one score line made and arranged to enable user-displacement of the oral hygiene unit in a manner to expose said toothpick extending ready to use.

14. The combination eating utensil and oral hygienic facilities as defined in claim 13 further comprising:
said toothpick, being formed centrally in said handle portion and outlined by a generally U-shaped void region extending away from the end region into the handle portion, thus forming a U-shaped guard arch in the handle portion for full protection around the toothpick for normal usage of the said eating utensil and said flosser, and
said handle portion being configured with a pair of score lines made and arranged to form living hinges extending from extremities of the U-shaped guard arch to nearby opposite handle side edges, enabling the oral hygiene unit including said toothpick and said dental flosser in combination to be bent back by a user with said flosser against said handle portion, so as to expose said toothpick extended and ready for use.

15. The combination eating utensil and oral hygienic facilities as defined in claim 1 wherein said eating utensil portion is a combined spoon and fork known as a spork

16. The combination eating utensil and oral hygienic facilities as defined in claim 44 1 wherein said and said toothpick is configured as an interdental brush-pick, made sufficiently thin and abrasive to enable cleaning and debris removal between adjacent teeth, configured with an enlarged base end portion made and arranged to serve as thumb-finger grip tab, disposed adjacent to said flosser and attached thereto by a score line along a base end edge made and arranged to enable the interdental pick to be user-displaced in a manner to expose the interdental brush-pick extended and ready for use.

17. The combination eating utensil and oral hygienic facilities as defined in claim 1 wherein said toothpick is configured as an interdental brush-pick, made sufficiently thin and abrasive to enable cleaning and debris removal between adjacent teeth, configured with an enlarged base end portion made and arranged to serve as thumb-finger arm tab, disposed adjacent to said flosser and attached thereto by a score line along a base end edge made and arranged to enable the interdental brush-pick to be user-displaced in a manner to expose the interdental pick extended and ready for use.

18. The combination eating utensil and oral hygienic facilities as defined in claim 1 further comprising:
a tongue cleaner;
an oral brush; and
said handle portion being molded from plastic and configured with the end region permanently bent back to a predetermined angle to facilitate flossing.

19. The combination eating utensil and oral hygienic facilities as defined in claim 1 wherein said handle portion is molded from plastic and includes a region thereof configured and arranged to constitute a tongue cleaner.

20. The combination eating utensil and oral hygienic facilities as defined in claim 19 further comprising an oral brush mounted on said handle portion.

21. The combination eating utensil and oral hygienic facilities as defined in claim 1 further comprising at least one additional oral hygienic device selected from a group including a toothpick, and interdental pick, an interdental brush, a tongue cleaner, a bristle brush and an oral brush.

22. The combination eating utensil and oral hygienic facilities as defined in claim 1 further comprising at least one displacement-enabling score line configured in said handle portion, made and arranged to initially hold an oral hygienic device in a protected place and, upon an act of displacement by a user, to expose the oral hygienic device ready to use.

23. The combination eating utensil and oral hygienic facilities as defined in claim 1 further comprising at least one displacement-enabling score line configured in said handle portion, made and arranged to initially hold an oral hygienic device in a protected region of said handle portion, and to enable a user to bend away the protected region of said handle and thus expose the oral hygienic device ready to use.

24. The combination eating utensil and oral hygienic facilities as defined in claim 1 further comprising at least one displacement-enabling score line configured in said handle portion, made and arranged to initially hold an oral hygienic device in place, and to enable a user to snap off and remove the oral hygienic device so as to be exposed ready to use as a separate device.
